(19) United States
(12) Patent Application Publication
(10) Pub. No.: US 2010/0310745 A1
(43) Pub. Date: Dec. 9, 2010

(54) FLAVORING COMPOSITIONS FOR SAVORY APPLICATIONS

(76) Inventors: Christian Starkenmann, Onex (CH); Roger Snowden, Viry (FR); Simon Linder, Onex (CH); Patrick Weil, Peron (FR)

Correspondence Address: WINSTON & STRAWN LLP;PATENT DEPARTMENT, 1700 K STREET, N.W., WASHINGTON, DC, 20006, US

(21) Appl. No.: 12/676,630

(22) PCT Filed: Sep. 10, 2008
(86) PCT No.: PCT/IB2008/053647

§ 371 Date: Mar. 5, 2010

(30) Foreign Application Priority Data
Sep. 13, 2007 (IB) 2007/053691

(51) Int. Cl. A23L 1/226

(52) U.S. Cl. 426/537

(57) ABSTRACT

A method for conferring, enhancing, improving or modifying savory, roast or caramel notes in a flavoring composition or flavored food, by adding to the composition or food a flavour effective amount of a compound of formula (I),

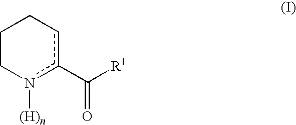

as a flavoring ingredient, wherein the dotted lines represent each a single or double bond, n represents 0 if the compound is an amine or is 1 if the compound is an amine and R1 represents a methyl or ethyl group, with the compound being in the form of a free base or of an edible salt thereof. Also, the flavouring compositions or flavoured articles provided by the method.

### TECHNICAL FIELD

The present invention relates to the field of flavors. More particularly, it concerns the use of some acyl piperidyls or acyl tetrahydro-piridines as flavoring ingredients to impart or reinforce the savory, roast notes.

Furthermore, the present invention concerns also the compositions or articles containing at least one of said compounds.

### PRIOR ART

Acyl piperidyls or acyl tetrahydro-piridines in general are known in prior art as compounds possessing a rice, cereal or noodles flavor (e.g. see R. Naef et al. in J. Agric. Food Chem. 2005, 53, 9161). However, none of the prior art documents mentioning said compounds anticipates, reports or suggests that said compounds have organoleptic properties that can be used to impart or reinforce savory notes, which are totally different from the cereal types mentioned above.

### DESCRIPTION OF THE INVENTION

We have now surprisingly discovered that a compound of formula

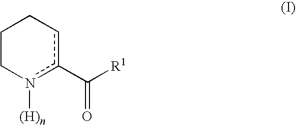

wherein the dotted lines represent each a single or double bond, n represents 0 if the compound is an amine or is 1 if the compound is an amine and R¹ represents a methyl or ethyl group, said compound being in the form of a free base or of an edible salt thereof;
   can be used as flavoring ingredient, for instance to impart or reinforce the savory, roast notes and/or caramel notes of a flavoring composition or of a flavored food.

According to a particular embodiment of the invention, said compound is a compound of formula (I), wherein the dotted lines represent single bonds and n is 1 and is in the form of an edible salt.

By the expression “edible salt” we mean here a salt obtained by reacting the free base with an acid which is edible. As non-limiting examples of said acid one may cite HCl, acidic sulfates (e.g. sulfuric acid or hydrogeno sulfates), or acidic phosphates (e.g phosphoric acid or hydrogeno phosphates), carbonic acids (e.g. H₂CO₃ or hydrogeno carbonates) or C₂-C₂₀ carboxilic acids.

Yet, according to a further embodiment, said compound is an edible salt of 1-(2-piperidinyl)-1-propanoate (also known as conhydrinone), and in particular any one of its chloride, sulfate or carbonate salts.

As mentioned above, the invention concerns the use of a compound of formula (I) as flavoring ingredient, and in particular to impart savory, roast notes and/or caramel notes. Typically the present savory, roast notes include meat, onion, garlic and/or soy type tonalities, and in particular those having fried, roasted, cooked aspects. Similarly, the present caramel notes include toffee, butterscotch, candy floss type tonalities, and in particular those having burnt, caramelized, molasses, vanilla aspects.

According to a particular embodiment of the invention, such use is very much appreciated by flavorists to impart the taste of roasted meat, such as chicken, beef, lamb, duck, as well as to enhance the fleshy, juicy and cooked types of notes.

In other words it concerns a method to confer, enhance, improve or modify the flavor properties, as indicated above, of a flavoring composition or of a flavored article, which method comprises adding to said composition or article an effective amount of at least a compound of formula (I). By “use of a compound of formula (I)” it has to be understood here also the use of any composition containing compound (I) and which can be advantageously employed in the flavor industry as active ingredients.

Said compositions, which in fact can be advantageously employed as flavoring ingredients, are also an object of the present invention.

Therefore, another object of the present invention is a flavoring composition comprising:
i) as flavoring ingredient, at least one invention's compound as defined above;
ii) at least one ingredient selected from the group consisting of a flavor carrier and a flavor base; and
iii) optionally at least one flavor adjuvant.

According to a particular embodiment of the invention, said flavoring composition comprises:
i) as flavoring ingredient, at least one invention's compound as defined above;
ii) a flavor base of the savory, roast and/or caramel type; and
iii) optionally at least one ingredient selected from the group consisting of a flavor carrier and flavor adjuvant.

By “flavor carrier” we mean here a material which is practically neutral from a flavor point of view, i.e. that does not significantly alter the organoleptic properties of flavoring ingredients. Said carrier may be a liquid or a solid.

As liquid carrier one may cite, as non-limiting examples, an emulsifying system, i.e. a solvent and a surfactant system, or a solvent commonly used in flavors. A detailed description of the nature and type of solvents commonly used in flavor cannot be exhaustive. However, one can cite as non-limiting example solvents such as propylene glycol, triacetine, triethyl citrate, benzylic alcohol, ethanol, vegetal oils or terpenes.

As solid carrier one may cite, as non-limiting examples, absorbing gums or polymers, or yet encapsulating materials. Examples of such materials may comprise wall-forming and plasticizing materials, such as mono, di- or trisaccharides, natural or modified starches, hydrocolloids, cellulose derivatives, polyvinyl acetates, polyvinylalcohols, proteins or pectins, or yet the materials cited in reference texts such as H. Scherz, Hydrokolloids: Stabilisatoren, Dickungs- and Gehermittel in Lebensmittel, Band 2 der Schriftenreihe Lebensmittelchemie, Lebensmittelqualität, Behr's VerlagGmbH & Co., Hamburg, 1996. The encapsulation is a well known process to a person skilled in the art, and may be performed, for instance, using techniques such as spray-drying, agglomeration or yet extrusion; or consists of a coating encapsulation, including coacervation and complex coacervation techniques.

By “flavor base” we mean here a composition comprising at least one flavoring co-ingredient.

Said flavoring co-ingredient is not of the formula (I). Moreover, by “flavoring co-ingredient” it is meant here a compound, which is used in flavoring preparations or compositions to impart a hedonic effect. In other words such a co-ingredient, to be considered as being a flavoring one, must be recognized by a person skilled in the art as being able to impart or modify in a positive or pleasant way the taste of a composition, and not just as having a taste.

The nature and type of the flavoring co-ingredients present in the base do not warrant a more detailed description here, which in any case would not be exhaustive, the skilled person being able to select them on the basis of its general knowledge and according to intended use or application and the desired organoleptic effect. In general terms, these flavoring co-ingredients belong to chemical classes as varied as alcohols, aldehydes, ketones, esters, ethers, acetates, nitriles, terpenoids, nitrogenous or sulphurous heterocyclic compounds and essential oils, and said perfuming co-ingredients can be of natural or synthetic origin. Many of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of flavor. It is also understood that said co-ingredients may also be compounds known to release in a controlled manner various types of flavoring compounds.

However, according to a particular embodiment of the invention, said flavor base advantageously comprises at least a compound of formula

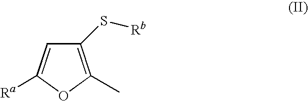

wherein R^{a} represents a hydrogen atom or a methyl group, and R^{b} represents a methyl or ethyl group, an acetyl group, or a C₃-C₁₀ group comprising a carbonyl group. These compounds are known to impart meaty notes in flavors.

In a particular embodiment R^{b} is a group such as methyl, acetyl, 2-furan-carnonyl, 1-methyl-3-oxo-butyl, 1-methyl-3-oxo-propyl, 1-ethyl-3-oxo-propyl, 1-propyl-3-oxo-propyl, 1,1-dimethyl-3-oxo-propyl, 1-pentyl-5-oxo-pent-3-enyl. In a particular embodiment R^{a} is a hydrogen atom.

Non-limiting examples of compounds (II) are S-(2-5-dimethyl-3-furyl) 2-furancarbothionate, S-(2-methyl-3-furyl)ethanethionate, 3-[(2-methyl-3-furyl)thio]butanal or 2-methyl-3-(methylthio)furan.

Therefore a flavoring composition comprising at least a compound of formula (I) and at least a compound of formula (II) is also an object of the present invention.

By “flavor adjuvant” we mean here an ingredient capable of imparting additional added benefit such as a color, a particular light resistance, chemical stability, etc. A to detailed description of the nature and type of adjuvant commonly used in flavoring bases cannot be exhaustive, but it has to be mentioned that said ingredients are well known to a person skilled in the art.

An invention's composition consisting of at least one compound of formula (I) and at least one flavor carrier represents a particular embodiment of the invention as well as a flavoring composition comprising at least one compound of formula (I), at least one flavor carrier, at least one flavor base, and optionally at least one flavor adjuvant.

It is useful to mention here that the possibility to have, in the compositions mentioned above, more than one compound of formula (I) is important as it enables the flavorist to prepare accords, flavors, possessing the flavor tonality of various compounds of the invention, creating thus new tools for his work.

Preferably, any mixture resulting directly from a chemical synthesis, e.g. without an adequate purification, in which the compound of the invention would be involved as a starting, intermediate or end-product could not be considered as a flavoring composition according to the invention.

Moreover, a compound of formula (I) can be advantageously incorporated into flavored articles to positively impart, or modify, the taste of said articles. Consequently, a flavored article comprising:
i) as flavoring ingredient, at least one compound of formula (I), as defined above, or an invention's flavoring composition; and
ii) a foodstuff base;
   is also an object of the present invention.

Suitable foodstuff bases, e.g. foods or beverages, include savory cubes, instant soup, canned soups, preserved meat, instant noodles, frozen dishes and preparations, sauces in all forms, such as cooked tomato sauces derivatives, flavored oils and/or spreads, toffees, alcoholic beverages having molasses/caramelic notes such as rhum and sugar cane derived beverages. Other suitable foodstuff bases could be snacks and biscuits, or pizzas (frozen or ready to cook).

For the sake of clarity, it has to be mentioned that, by “foodstuff base” we mean here an edible product, e.g. a food or a beverage. Therefore, a flavored article according to the invention comprises the functional formulation, as well as optionally additional to benefit agents, corresponding to a desired edible product, e.g. a savory cube, and a flavor effective amount of at least an invention's compound.

The nature and type of the constituents of the foodstuffs or beverages do not warrant a more detailed description here, which in any case would not be exhaustive, the skilled person being able to select them on the basis of his general knowledge and according to the nature of said product.

The proportions in which the compounds according to the invention can be incorporated into the various aforementioned articles or compositions vary within a wide range of values. These values are dependent on the nature of the article to be flavored and on the desired organoleptic effect as well as the nature of the co-ingredients in a given base when the compounds according to the invention are mixed with flavoring co-ingredients, solvents or additives commonly used in the art.

In the case of flavoring compositions, typical concentrations are in the order of 0.0001% to 1% by weight, or even more, of the compounds of the invention based on the weight of the consumer product into which they are incorporated. Concentrations lower than these, such as in the order of 0.001% to 0.5% by weight, can be used when these compounds are incorporated into flavored articles, percentage being relative to the weight of the article.

### EXAMPLES

The invention will now be described in further detail by way of the following example, wherein the abbreviations have the usual meaning in the art.

### Example 1

Flavoring Compositions and Flavored Article According to the Invention

Two flavoring compositions, (A) and (B), for a meat application was prepared by admixing the following ingredients:

| | Composition (A) | Composition (B) |
|---|---|---|
| Ingredient | Parts by weight | Parts by weight |
| C6 Aldehyde | 25 | 25 |
| 10%* 2-Furanmethanethiol | 80 | 80 |
| 7-Methyl-3-octen-2-one | 5 | 5 |
| Furaneol ®¹⁾ | 30 | 30 |
| 10%** 3-Mercapto-3-methyl-1-butanol | 20 | 20 |
| 10%** 3-Mercapto-2-methylpentanal | 20 | 20 |
| 10%** Methylfuryl disulfure | 25 | 25 |
| 10%** Methyl Mercaptan | 10 | 10 |
| 10%*** Methyl pentyl ketone | 10 | 10 |
| 10%** Tetrahydromethyl furanthiol | 20 | 20 |
| 10%** 3-[(2-Methyl-3-furyl)thio]butanal | 5 | 5 |
| 5%** [1-(2-Piperidinyl)-1-propanoate]HCl | — | 30 |
| PG | 750 | 720 |
| Total | 1000 | 1000 |

¹⁾4-Hydroxy-2,5-dimethyl-3(2H)-furanone; origin: Firmenich SA, Geneva, Switzerland
*triacetine;
**propylene glycol;
***triethyl citrate

To a portion of a standard unflavored chicken instant soup were added 5 ppm, relative to the weight of the soup, of the flavoring composition (A).
To the other portion of the above unflavored instant chicken soup were added 5 ppm relative to the weight of the soup, of the flavoring composition (B).
There were thus obtained two flavored instant chicken soups, one containing compound (I) and the other not containing it.
The soup containing composition (A) has a chicken character though quite fatty, aldehydic with a present and offensive sulfury top note.
By comparison, the soup containing composition (B) has a much more rounded taste that can be described as harmonious balance between fatty-aldehydic skin notes and fleshy white meat taste. An overall savory-culinary taste is present too that can be described as a warm, cooked, naturally cooked without any processed character.
This type of flavor can be applied whenever the savory-culinary and naturally cooked character are required, such as instant noodles, canned or instant dried soup, savory cubes, sauce preparation in any form, flavored cooking oil, etc.

1.-8. (canceled)

9. A method for conferring, enhancing, improving or modifying savory, roast or caramel notes in a flavoring composition or flavored food, which comprises adding to the composition or food a flavour effective amount of a compound of formula (I), 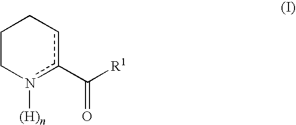
as a flavoring ingredient, wherein the dotted lines represent each a single or double bond, n represents 0 if the compound is an amine or is 1 if the compound is an amine and R¹ represents a methyl or ethyl group, with the compound being in the form of a free base or of an edible salt thereof.

10. The method of claim 9, wherein the compound is in the form of an edible salt of an acid selected from the group consisting of HCl, acidic sulfates, or acidic phosphates, carbonic acids and C₂-C₂₀ carboxilic acids.

11. The method of claim 9, wherein the compound is an edible salt of 1-(2-piperidinyl)-1-propanoate.

12. A flavoring composition comprising:
i) as a flavoring ingredient, at least one compound of formula (I), 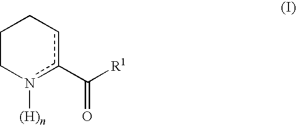
wherein the dotted lines represent each a single or double bond, n represents 0 if the compound is an amine or is 1 if the compound is an amine and R1 represents a methyl or ethyl group, with the compound being in the form of a free base or of an edible salt thereof;
ii) at least one ingredient selected from the group consisting of a flavor carrier and a flavor base; and
iii) optionally at least one flavor adjuvant.

13. The flavoring composition according to claim 12, further comprising at least one compound of formula 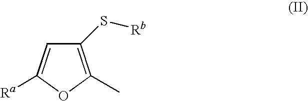
wherein Ra represents a hydrogen atom or a methyl group, and Rb represents a methyl or ethyl group, an acetyl group, or a C₃-C₁₀ group comprising a carbonyl group.

14. The flavoring composition according to claim 12, wherein the flavor base is of the savory, roast or caramel type.

15. The flavoring composition according to claim 12, wherein the compound is an edible salt of 1-(2-piperidinyl)-1-propanoate.

16. A flavored article comprising:
i) at least one compound of formula (I), 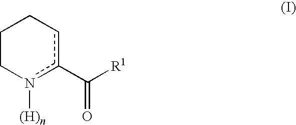
wherein the dotted lines represent each a single or double bond, n represents 0 if the compound is an amine or is 1 if the compound is an amine and R1 represents a methyl or ethyl group, with the compound being in the form of a free base or of an edible salt thereof; and
ii) a foodstuff base.

17. The flavored article according to claim 16, wherein the foodstuff base is a savory cube, an instant soup, a canned soup, a preserved meat, instant noodles, a frozen dish or preparation, a sauce, a flavored oil or spread, a toffee, an alcoholic beverage having molasses or caramelic notes, a snack or biscuit, or a pizza.

18. The flavored article according to claim 16, wherein the compound is an edible salt of 1-(2-piperidinyl)-1-propanoate.

19. A flavored article comprising:
i) a flavoring composition as defined in claim 12; and
ii) a foodstuff base.

20. The flavored article according to claim 19, wherein the foodstuff base is a savory cube, an instant soup, a canned soup, a preserved meat, instant noodles, a frozen dish or preparation, a sauce, a flavored oil or spread, a toffee, an alcoholic beverage having molasses or caramelic notes, a snack or biscuit, or a pizza.

21. The flavored article according to claim 20, wherein the compound is an edible salt of 1-(2-piperidinyl)-1-propanoate.
